(19) United States
(12) Patent Application Publication
(10) Pub. No.: US 2014/0176505 A1
(43) Pub. Date: Jun. 26, 2014

(54) IMAGE DISPLAY DEVICE AND INPUT DETERMINATION METHOD

(71) Applicant: Funai Electric Co., Ltd., Osaka (JP)

(72) Inventors: Manabu ARAI, Osaka (JP); Keiji WANAKA, Osaka (JP)

(73) Assignee: Funai Electric Co., Ltd., Osaka (JP)

(21) Appl. No.: 14/135,726

(22) Filed: Dec. 20, 2013

(30) Foreign Application Priority Data
Dec. 20, 2012 (JP) 2012-277608
Dec. 27, 2012 (JP) 2012-283861

(51) Int. Cl. G06F 3/041; G06F 3/042

(52) U.S. Cl. CPC G06F 3/0418; G06F 3/0428
USPC 345/175

(57) ABSTRACT

An image display device includes an image display component, a detector, and an error determination component. The image display component is configured to project on a projection surface a projection image with at least first and second input objects for a user input operation using an indicator. The first and second input objects are adjacently arranged in the projection image with a spacing therebetween. The detector is configured to detect the indicator in a detection range that extends in a height direction of the projection surface. The error determination component is configured to determine that the user input operation of the second input object is erroneously detected in response to the detector continuously detecting the indicator in regions of the detection range corresponding to the first input object, the spacing and the second input object, respectively.

### CROSS-REFERENCE TO RELATED APPLICATIONS

This application claims priority to Japanese Patent Application Nos. 2012-277608 filed on Dec. 20, 2012 and 2012-283861 filed on Dec. 27, 2012. The entire disclosures of Japanese Patent Application Nos. 2012-277608 and 2012-283861 are hereby incorporated herein by reference.

### BACKGROUND

1. Field of the Invention

The present invention generally relates to an image display device and an input determination method. More specifically, the present invention relates to an image display device that receives a user input manipulation on a projected manipulation screen, and an input determination method carried out by the image display device.

2. Background Information

One known input interface for electronic devices is an input device with which manipulation can be performed by having the user directly touch a projected image.

A conventional electronic device is well known in the art with which a beam from an infrared laser (light source) is scanned with part of a MEMS mirror (a projector scanning means) of a projector module (see Japanese Laid-Open Patent Application Publication No. 2009-258569, for example). With this device, the light is made parallel to an installation surface by a reflecting mirror. When a specific place on a projected image is touched with a finger, the infrared beam (invisible light) reflected by the finger is directed at a photodiode by a beam splitter, and the distance to the finger is measured by TOF method with a ranging means.

### SUMMARY

It has been discovered that with an input device that recognizes an object indicated by reflected light from a finger or another such indicator when the user touches a specific object in a projected and displayed image with the indicator, if there are a plurality of objects, even though the user has indicated one object, it ends up being detected that another object has been indicated.

One object of the present disclosure is to determine whether an object indicated by a user by input manipulation has been erroneously detected, for a plurality of objects included in a projected and displayed manipulation-use image.

Another object of the present disclosure is to prevent erroneous detection of objects indicated by a user in an image display device for projecting and displaying a manipulation-use image including a plurality of objects with which the user performs input manipulation.

In view of the state of the know technology, an image display device includes an image display component, a detector, and an error determination component. The image display component is configured to project on a projection surface a projection image with at least first and second input objects for a user input operation using an indicator. The first and second input objects are adjacently arranged in the projection image with a spacing therebetween. The detector is configured to detect the indicator in a detection range that extends in a height direction of the projection surface. The error determination component is configured to determine that the user input operation of the second input object is erroneously detected in response to the detector continuously detecting the indicator in regions of the detection range corresponding to the first input object, the spacing and the second input object, respectively.

Other objects, features, aspects and advantages of the present disclosure will become apparent to those skilled in the art from the following detailed description, which, taken in conjunction with the annexed drawings, discloses selected embodiments of an image display device and an input determination method.

### BRIEF DESCRIPTION OF THE DRAWINGS

Referring now to the attached drawings which form a part of this original disclosure:

FIG. 1 is a perspective view of an external configuration of laser projector in accordance with a first embodiment;

FIG. 2 is a schematic block diagram of an internal configuration of the laser projector illustrated in FIG. 1;

FIG. 3 is a schematic diagram illustrating manipulation of the laser projector;

FIGS. 4(a) and 4(b) are schematic diagrams illustrating manipulation detection of the laser projector;

FIGS. 5(a) and 5(b) are schematic diagrams illustrating object indication manipulation of the laser projector;

FIGS. 6(a) and 6(b) are schematic diagrams illustrating detection processing of the laser projector;

FIG. 7 is a schematic diagram illustrating object indication manipulation and detection processing of the laser projector;

FIG. 8 is a flowchart illustrating erroneous detection determination processing of the laser projector;

FIG. 9 is a flowchart illustrating key layout adjustment processing of the laser projector;

FIGS. 10(a) and 10(b) are schematic diagrams illustrating erroneous detection of a laser projector in accordance with a second embodiment;

FIGS. 11(a) and 11(b) are schematic diagram illustrating erroneous detection avoidance of the laser projector;

FIGS. 12(a) to 12(c) are schematic diagram of a jig for height detection of the laser projector;

FIG. 13 is a screen image of a height input screen of the laser projector;

FIG. 14 is a correspondence table storing relations between detection height and key spacing;

FIG. 15 is a schematic diagram illustrating object spacing change of the laser projector;

FIG. 16 is a correspondence table storing relations between detection height and key size;

FIGS. 17(a) and 17(b) are schematic diagrams illustrating erroneous detection avoidance of the laser projector;

FIG. 18 is a flowchart illustrating height detection processing of the laser projector;

FIG. 19 is a flowchart illustrating object spacing change processing of the laser projector; and

FIG. 20 is a flowchart illustrating another object spacing change processing of the laser projector.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

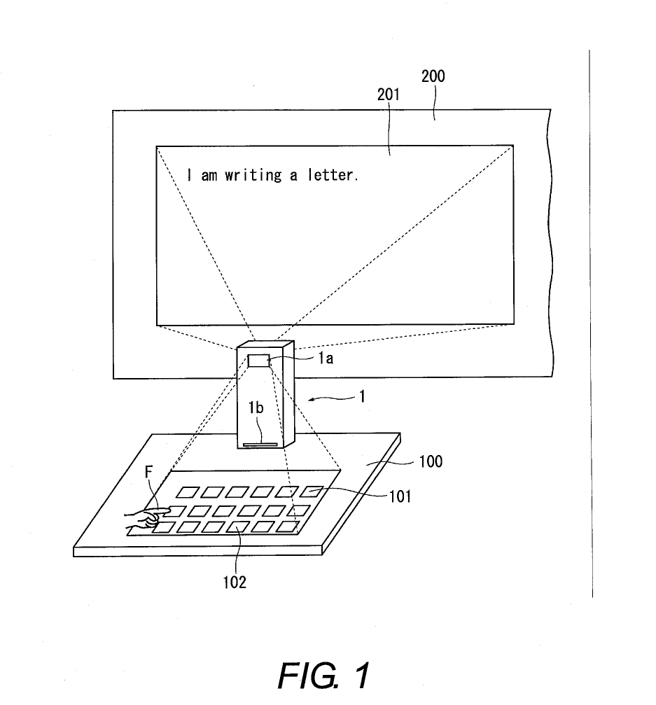

Referring initially to FIG. 1, a laser projector (e.g., an image display device) is illustrated in accordance with a first embodiment. Built into this laser projector 1 is an input device of the present invention.

The laser projector 1 in the illustrated embodiment is installed on a table 100, a display-use image 201 is projected and displayed on a screen or other such projection surface 200 (e.g., an additional projection surface) by scanning the laser beam, and a manipulation-use image 101 is projected and displayed on the upper face, etc., of the table or other such projection surface 100 (e.g., a projection surface). In the illustrated embodiment, the manipulation-use image 101 is projected by directing the laser from a window 1a in the projector housing provided on the opposite side from the side where the display-use image 201 is projected. It is preferable if the manipulation-use image or display-use image is scanned and projected with a laser beam because a sharper image can be projected and displayed, among other advantages.

The laser projector 1 in the illustrated embodiment projects and displays different images for the display-use image 201 and the manipulation-use image 101, with the manipulation-use image 101 being a keyboard image including letters or other such text keys that are manipulated by the user (e.g., projection keyboard), and the display-use image 201 being text having letters and symbols inputted by key operation by the user.

The letter keys included in the manipulation-use image 101 are objects 102 indicated (touched) with a finger or other such indicator F by manipulation input from the user. The laser projector 1 in the illustrated embodiment is such that the display-use image 201 is an input interface for a personal computer, and the manipulation-use image 101 is an output interface for a personal computer, for example. A plurality of these keys 102 are provided, and the keys 102 are disposed spaced apart.

The display-use image 201 and the manipulation-use image 101 need not be totally different images as in this example, and instead can be partially different images, or can be the same images, as long as a plurality of the objects 102 indicated by manipulation input from the user are included in the manipulation-use image 101.

With the laser projector 1 in the illustrated embodiment, which of the objects 102 has been indicated is determined by detecting the laser light projecting the manipulation-use image 101 and reflected by the indicator F, where the indicator F is a finger indicating an object 102 out of the manipulation-use image 101. The laser light that passes through a window 1b provided to the lower part of the projector 1 and is reflected by the indicator F is incident on a detector 19 provided inside the projector housing.

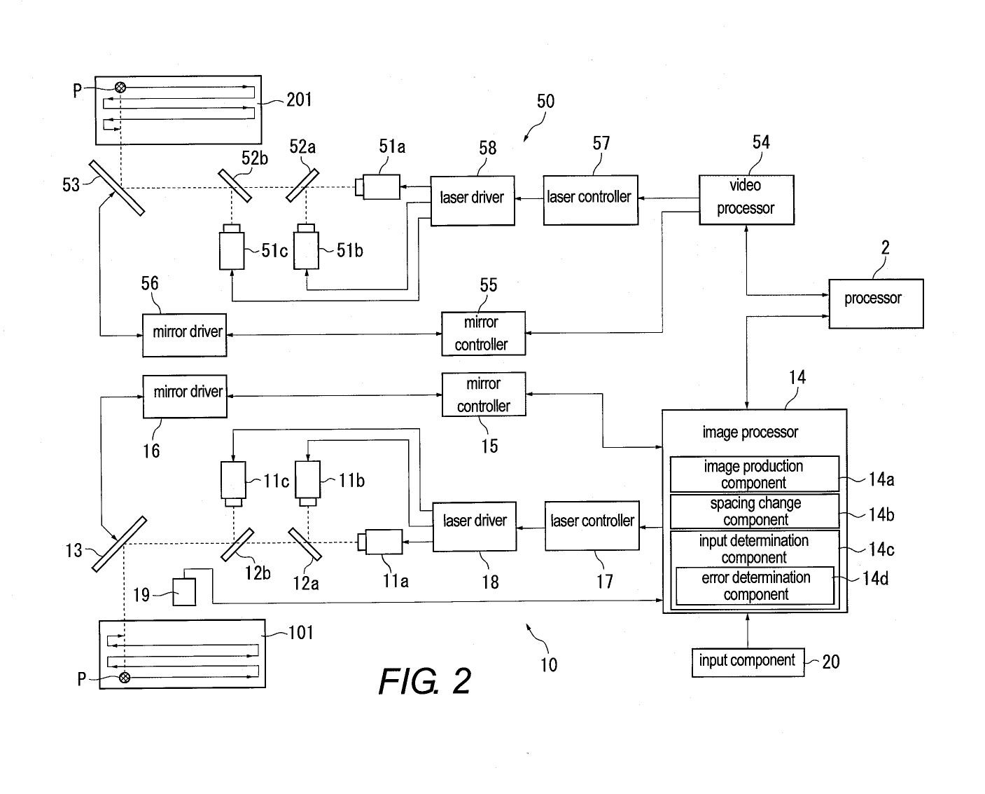

FIG. 2 shows the internal configuration of the main components of the laser projector 1 pertaining to this embodiment. This laser projector 1 includes an input device component 10 (e.g., an image display component) related to the projection of the manipulation-use image 101 (e.g., the projection image) and indicator detection, and a display device component 50 (e.g., an additional image display component) related to the projection of the display-use image 201 (e.g., the display image). The configuration is such that the input device component 10 and the display device component 50 are connected to a personal computer or other such processor 2.

Specifically, under control by the processor 2, the manipulation-use image 101 and the display-use image 201 are projected, and the input manipulation performed with the manipulation-use image 101 is shown in the display of the display-use image 201.

The display device component 50 has laser light sources 51a to 51c of red (R), green (G), and blue (B) color components, half mirrors 52a and 52b for combining these laser beams, a scanning mirror 53, and various drive and control units 54 to 58.

The display device component 50 combines the laser beams of the red (R), green (G), and blue (B) color components, and then scans this combined beam with the scanning mirror 53, thereby projecting a color image corresponding to a video signal inputted from the processor 2, as the display-use image 201.

The laser light sources 51a to 51c are laser diodes (LD) that each output a laser beam of a different color component. These are independently driven by drive current supplied individually from a laser driver 58, to output laser beams with single color components.

The laser beams emitted from the laser light sources 51a and 51b are combined at the half mirror 52a, this combined beam is then combined with the laser beam emitted from the laser light source 51c at the half mirror 52b, and this product is emitted toward the scanning mirror 53 as the final, targeted color combined light.

The scanning mirror 53 is a MEMS (Micro Electro Mechanical System) type of scanning mirror, which is scanned and displaced horizontally and vertically by a mirror driver 56 to which a drive signal is inputted from a mirror controller 55. The colored light incident on the scanning mirror 53 is reflected according to the deflection angle of the scanning mirror 53, a pixel spot p produced by this colored light is scanned horizontally and vertically over the projection surface 200, and the display-use image 201 is projected and displayed.

Information pertaining to the scanning position of the pixel spot p at which the image is projected from a video processor 54 is inputted to the mirror controller 55 and a laser controller 57, and the pixels at each scanning position are projected as the pixel spot p.

When an image is projected and displayed with a laser beam, it is preferable for the scanner used for scanning with the laser beam to be a MEMS type of scanning mirror because it is more compact, consumes less power, and affords faster processing, among other advantages.

The video processor 54 sends video data to the laser controller 57 at specific time intervals based on the video signal inputted from the processor 2. Consequently, the laser controller 57 obtains pixel information at a specific scanning position.

To project the display-use image 201, the laser controller 57 outputs to the laser driver 58 a drive current signal for scanning the pixel spot p over a projection range based on pixel information, and thereby controls the emission output of the laser light sources 51a to 51c.

The input device component 10 has laser light sources 11a to 11c of red (R), green (G), and blue (B) color components, half mirrors 12a and 12b for combining these laser beams, a scanning mirror 13, various drive and control units 14 to 18, the detector 19 that detects laser light reflected by the indicator F, and an input component 20 that receives mode designations and other such input from the user.

The input device component 10 combines the laser beams of the red (R), green (G), and blue (B) color components, and then scans this combined beam with the scanning mirror 13, thereby projecting a color image corresponding to a video signal inputted from the processor 2, as the manipulation-use image 101.

The laser light sources 11a to 11c are laser diodes (LD) that each output a laser beam of a different color component. These are independently driven by drive current supplied individually from a laser driver 18, to output laser beams with single color components.

The laser beams emitted from the laser light sources 11a and 11b are combined at the half mirror 12a, this combined beam is then combined with the laser beam emitted from the laser light source 11c at the half mirror 12b, and this product is emitted toward the scanning mirror 13 as the final, targeted color combined light.

The scanning mirror 13 is a MEMS type of scanning mirror, which is scanned and displaced horizontally and vertically by a mirror driver 16 to which a drive signal is inputted from a mirror controller 15. The colored light incident on the scanning mirror 13 is reflected according to the deflection angle of the scanning mirror 13, a pixel spot p produced by this colored light is scanned horizontally and vertically over the projection surface 100, and the manipulation-use image 101 is projected and displayed through the window 1a.

Information pertaining to the scanning position of the pixel spot p at which the image is projected from an image processor 14 is inputted to the mirror controller 15 and a laser controller 17, and the pixels at each scanning position are projected as the pixel spot p.

The image processor 14 sends video data to the laser controller 17 at specific time intervals based on the video signal inputted from the processor 2. Consequently, the laser controller 17 obtains pixel information at a specific scanning position.

To project the manipulation-use image 101, the laser controller 17 outputs to the laser driver 18 a drive current signal for scanning the pixel spot p over a projection range based on pixel information, and thereby controls the emission output of the laser light sources 11a to 11c.

The manipulation-use image 101 includes a plurality of the objects 102, and these objects 102 are specified as scanning positions of the pixel spot p at which the manipulation-use image 101 is displayed (that is, coordinate positions on the manipulation-use image 101).

The detector 19 is a photodiode (PD), and outputs a detection signal to the image processor 14 upon detecting reflected light.

Therefore, when the indicator F indicates (touches) a certain object, and the laser beam displaying the manipulation-use image 101 is reflected by the indicator F, this reflected light goes through the window 1b and is detected by the detector 19. Then, the image processor 14 determines that this object has been indicated from the timing at which this reflected light was detected and the scanning position of the pixel spot p. Specifically, the image processor 14 determines the coordinate position of the reflected light on each scan (that is, the position coordinates indicated by the indicator F) from the timing at which this reflected light was detected and the scanning position of the pixel spot p. Therefore, the image processor 14 sequentially determines for each manipulation the position coordinates indicated by the indicator F within the manipulation-use image 101, and determines that an object in the manipulation-use image 101 has been indicated, or that an area around an object has been indicated, etc.

The image processor 14 has an image production component 14a, a spacing change component 14b, an input determination component 14c, and an error determination component 14d. These have the function of controlling the manipulation-use image 101, and the function of determining the selection and indication of an object for the manipulation-use image 101.

The image processor 14, the laser light sources 11a to 11c, the half mirrors 12a and 12b, the scanning mirror 13, and the drive and control units 14 to 18 form a manipulation-use image display component for projecting and displaying on a projection surface a manipulation-use image including a plurality of objects with which the user performs input manipulation with an indicator.

The image production component 14a and the spacing change component 14b here are mainly utilized in an application example discussed below.

The image production component 14a produces the manipulation-use image 101 based on a video signal inputted from the processor 2, and the mirror controller 15 and the laser controller 17 perform control for the projection and display of the manipulation-use image 101 produced by the image production component 14a.

The spacing change component 14b outputs a command to the image production component 14a to change the spacing of the objects 102 included in the manipulation-use image 101 (in this example, the spacing of letter keys), and the image production component 14a produces the manipulation-use image 101 at an object spacing corresponding to this command.

As discussed above, the input determination component 14c determines which object 102 of the manipulation-use image 101 produced by the image production component 14a has been indicated by the indicator F, from the timing at which the detection signal from the detector 19 was inputted and the scanning position coordinates (or scanning position) of the pixel spot p of the manipulation-use image 101, and outputs the determination result to the processor 2.

The error determination component 14d determines a state (error state) in which it is unclear which of the objects 102 has been indicated by the indicator F in the above-mentioned determination by the input determination component 14c. The error determination component 14d further outputs this error state to the spacing change component 14b to change the object spacing of the manipulation-use image 101 produced by the image production component 14a.

Specifically, when the input determination component 14c determines which object 102 has been indicated based on the detection of reflected light from the indicator F indicating an object 102, a state in which it is unclear whether there has been input manipulation by the indicator F (that is, a state in which it is unclear which of two adjacent objects has been indicated) is determined by the error determination component 14d to be an erroneous detection.

The result of this erroneous detection is sent to the user by display output, acoustic output, or another such method to urge the user to input the information again.

With the application example discussed below, the error determination component 14d outputs an erroneous detection to the spacing change component 14b to change the object spacing in the manipulation-use image 101 produced by the image production component 14a. In this example, when the input determination component 14c determines which object 102 has been indicated based on the detection of reflected light from the indicator F indicating the object 102, a state in which it is unclear whether there has been input manipulation by the indicator F is determined by the error determination component 14d, and processing is performed to change the object spacing of the manipulation-use image 101 that is projected and displayed.

In the illustrated embodiment, the display-use image 201 and the manipulation-use image 101 are displayed as color images using laser light sources of different color components, but either of the images, or both, can be displayed instead as a single color.

Also, this embodiment can be applied to a mode in which the display-use image and the manipulation-use image are both the same image, as well as to a mode in which they are different images.

Also, this embodiment involves detecting the reflected laser beams displaying the manipulation-use image 101, but the configuration can be such that an invisible laser beam (such as an infrared laser) for detection use apart from these laser beams is also scanned, and the reflected light of the invisible laser beam is detected, thereby specifying the object 102 indicated by the indicator F.

Also, in the illustrated embodiment, the various control and function components included by the input device component 10 and the display device component 50 can be configured as a program module in which the computer hardware of the input device component 10 and the display device component 50 executes specific programs, but these control and function components can be configured as a dedicated module. Specifically, these control and function components can include a microcomputer with a control program. These control and function components can also include other conventional components such as an input interface circuit, an output interface circuit, and storage devices such as a ROM (Read Only Memory) device and a RAM (Random Access Memory) device. The microcomputer is programmed to control the laser projector 1. The memories store processing results and control programs. For example, the internal RAM stores statuses of operational flags and various control data. The internal ROM stores the control programs for various operations. These control and function components are capable of selectively controlling any of the components of the laser projector 1 in accordance with the control program. It will be apparent to those skilled in the art from this disclosure that the precise structure and algorithms for these control and function components can be any combination of hardware and software that will carry out the functions.

Next, the manipulation method with the indicator F (in this example, the finger of the user) on the manipulation-use image 101 will be described.

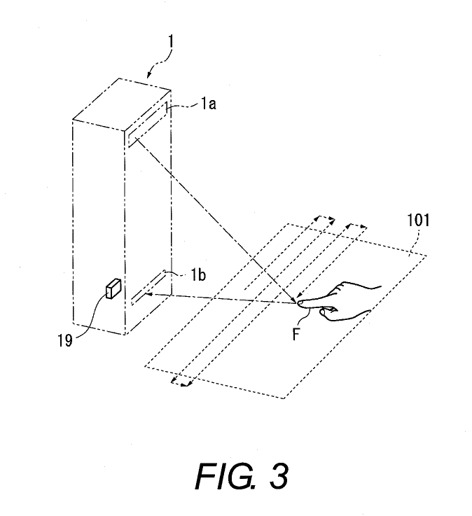

As shown in FIG. 3, the user indicates and selects (presses) an object included in the manipulation-use image 101 by putting a finger F on this object on the manipulation-use image 101 projected onto the projection surface 100 by the laser beam emitted obliquely downward from the window 1a.

The height range over which the detector 19 detects reflected light through the window 1b is about 10 mm, for example, from the surface of the manipulation-use image 101 (that is, the projection surface 100), and the laser beam reflected by the finger F placed against the object is detected by the detector 19.

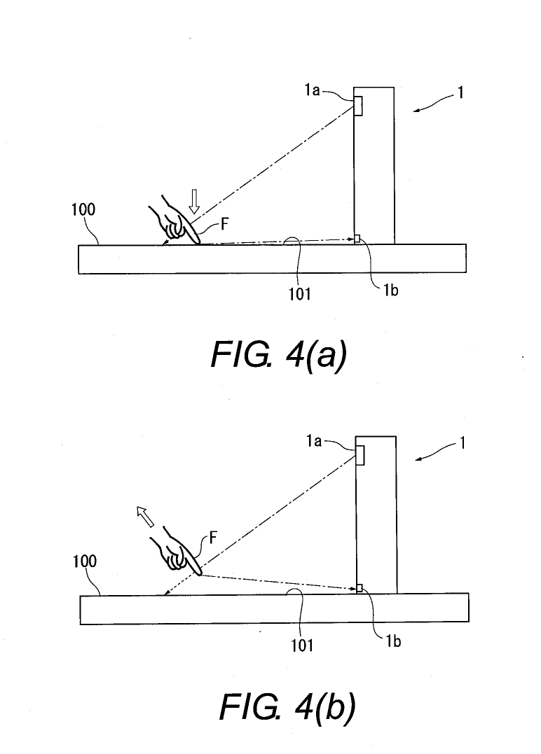

This manipulation for indicating and selecting an object can in most cases be done by movement of a finger as shown in FIGS. 4(a) and 4(b). Specifically, as shown in FIG. 4(a), the finger F is lowered straight down to press the desired object within the manipulation-use image 101, after which the finger F is lifted obliquely rearward (toward the user) as shown in FIG. 4(b).)

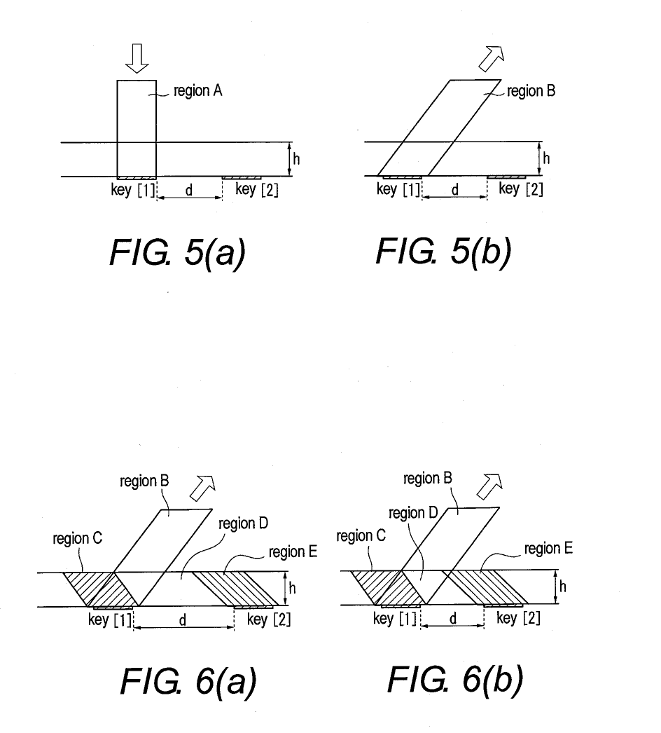

FIGS. 5(a) and 5(b) show the relation between the object and the movement of the finger F in this indication and selection manipulation, using as an example keys [1] and [2] (e.g., first and second input objects for a user input operation), which are two objects that are adjacently arranged in the manipulation-use image 101 with a spacing d therebetween. In FIGS. 5(a) and 5(b), h is the range of height over which the detector 19 detects reflected light.

As shown in FIG. 5(a), the finger F pressing the desired key [1] passes through a region A that goes substantially straight down through the detection range h of the detector 19. On the other hand, as shown in FIG. 5(b), the finger F lifted up from the key [1] passes through a region B that goes through the detection range h obliquely toward the key [2].

FIGS. 6(a) and 6(b) show the relation between the region B passed through by the finger F lifted from the key [1] and the adjacent key [2]. In FIGS. 6(a) and 6(b), the region C is the region of the laser beam projecting the key [1], the region D is the region of the laser beam projecting a spacing d portion between the key [1] and the key [2], and the region E is the region of the laser beam projecting the key [2].

As shown in FIG. 6(a), the region B passed through by the finger F lifted from the key [1] overlaps the region D of the spacing d portion within the detection range h, but if it does not overlap the region E of the key [2], it can be determined that the key [1] has been pressed by movement of the finger F.

As shown in FIG. 6(b), in contrast, when the finger F lifted from the key [1] (region B) passes through the region D and also passes through the region E, the detector 19 will detect reflected light from the finger F passing through the region E, so the input determination component 14c will end up erroneously detecting that the key [2] was also pressed after the key [1] was pressed.

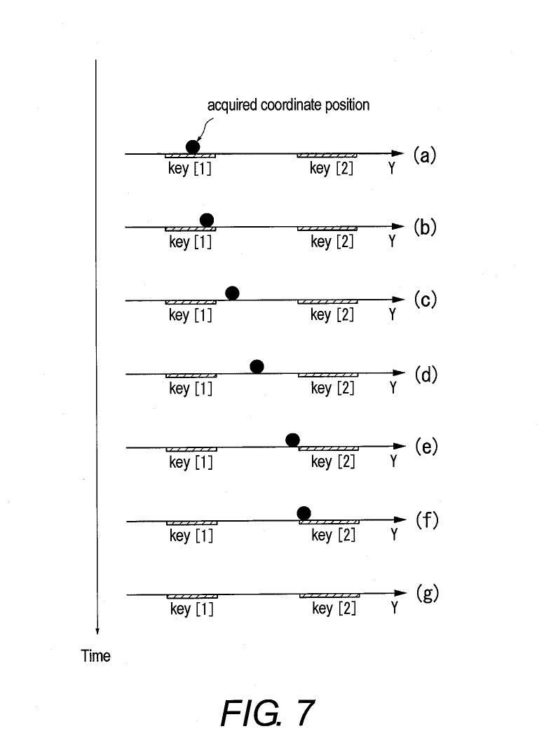

This situation will be described through reference to FIG. 7, which shows the change over time in the detected pressing position of the finger F (coordinate position).

The pressing coordinate position of the finger F is acquired at the point when the detector 19 detects the reflected light, but this coordinate position is first detected as being over the key [1] ((a) and (b) in FIG. 7) and then acquired as over the spacing d ((c) and (d) in FIG. 7), and then acquired as over the key [2] ((e) and (f) in FIG. 7), resulting in non-detection ((g) in FIG. 7) when the finger F is lifted out of the detection range h.

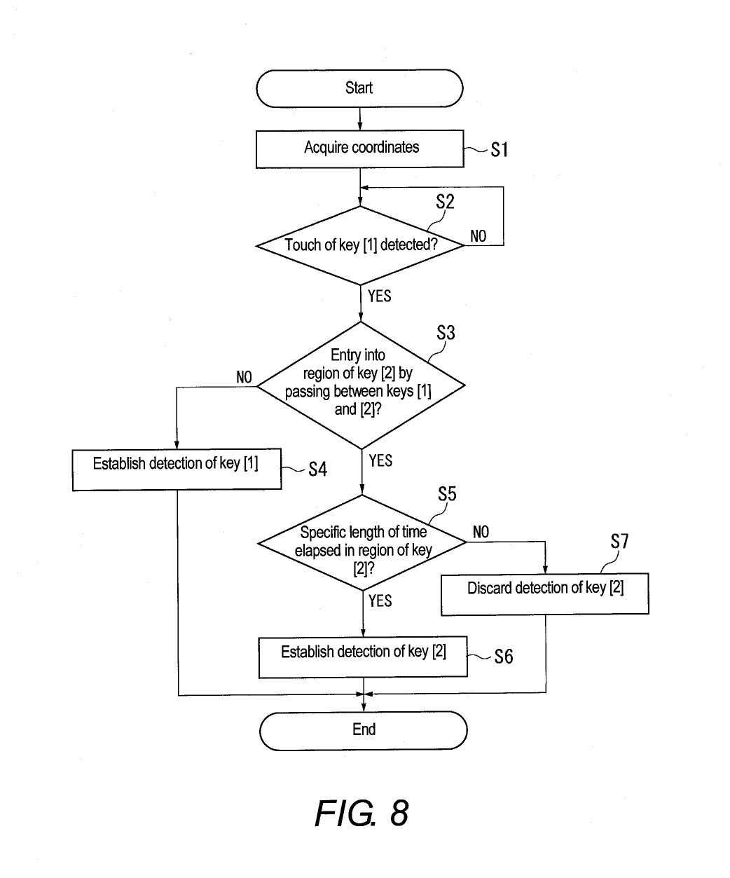

To deal with such a state in which it is unclear whether the key [2] has been pressed, the error determination component 14d performs the erroneous detection determination processing shown in FIG. 8, and if it is detected that the key [2] was pressed continuously after the key [1] was pressed, it is determined whether or not the detection of the key [2] (coordinate acquisition) is erroneous detection.

First, the coordinates of the finger F within the detection range h are sequentially acquired based on the projection and scanning timing of the manipulation-use image 101 and the reflected light detection timing by the detector 19 (step Si), and it is determined that the pressing (touching) of the key [1] has been detected from the acquired coordinates (step S2).

It is then determined whether the acquired coordinates have entered the region E of the key [2] through the spacing d (region D) between the keys [1] and [2] (step S3).

If the result of the above determination is that there is no entry into the region D of the spacing d, then the finger F has been lifted straight up, etc., and it is established that the user pressed the key [1] for which a touch was detected (step S4). Furthermore, if there is entry into the region D of the spacing d, but no entry into the region E of the key [2], then there has been no manipulation in the state shown in FIG. 6(a), and it is established that the user has pressed the key [1] for which a touch was detected (step S4).

On the other hand, if the acquired coordinates go through the spacing d (region D) between the keys [1] and [2] and enter the region E of the key [2], then it is determined whether or not the acquired coordinates have spent a specific length of time within the region E of the key [2] (step S5).

This determines whether the user has intentionally pressed (touched) the key [2] after the key [1]. If a specific length of time (e.g., a predetermined time period) has elapsed, then it is established that the key [2] was also pressed (step S6). This specific length of time can be preset to the length of time a given key is held down in normal key manipulation.

On the other hand, if the acquired coordinates have exited the region E of the key [2] without spending the specific length of time there, the result is the state shown in FIG. 6(b), in which the finger F goes through the region E of the key [2] in the course of being lifted, which is contrary to the user's intention, and the detection of this key [2] is discarded as an erroneous detection (step S7). In other words, the error determination component 14d determines that the user input operation of the key [2] is erroneously detected (step S7) in response to the detector 19 continuously determining the finger F in the regions C, D, E of the detection range corresponding to the key [1], the spacing d and the key [2], respectively (step S3). Furthermore, the error determination component 14d determines that the user input operation of the key [2] is erroneously detected (step S7) in response to the detector 19 detecting the finger F in the region E of the detection range corresponding to the key [2] for a time period that is shorter than the specific length of time before the detector 19 stops detecting the finger F in the region E of the detection range corresponding to the key [2] (step S5).

The result of the series of determination processing performed by the error determination component 14d is inputted to the input determination component 14c, and the input determination component 14c determines that the key was pressed in a state in which erroneous detection has been eliminated.

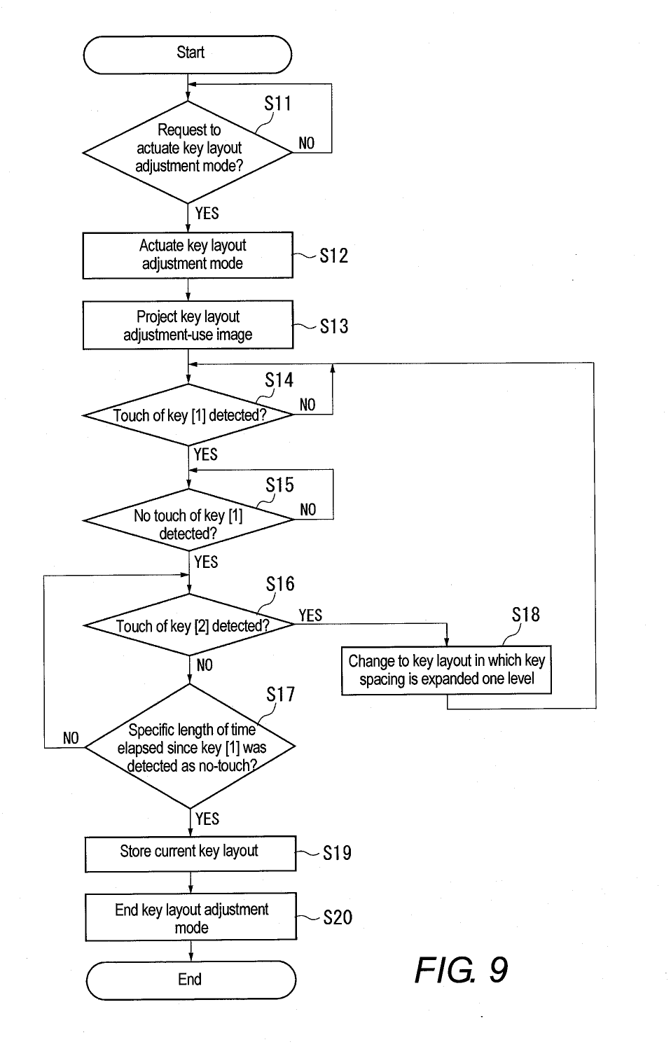

FIG. 9 shows an application example of this embodiment to a modification of the key spacing (object spacing).

As discussed above, the problem of erroneous detection occurs when the finger F that has pressed the key [1] passes through the region of the key [2], but erroneous detection can be prevented by expanding the spacing d between the keys [1] and [2] (see FIGS. 6(a) and 6(b)).

In this application example, the error determination component 14d determines erroneous detection of key pressing by the user, and as a result, the image production component 14a and spacing change component 14b of the image processor 14 perform key layout adjustment mode processing in which the key spacing is changed in the manipulation-use image 101.

In the key layout adjustment mode shown in FIG. 9, when input from the user designating the mode is received from the input component 20 (step S11), the image processor 14 actuates the key layout adjustment mode (step S12), the image production component 14a produces a key layout adjustment-use image, and this is projected as discussed above on the projection surface 100 (step S13).

The key layout adjustment-use image can be an ordinary manipulation-use image, rather than preparing a special image.

In the key layout adjustment mode, the user performs manipulation in which one of the plurality of objects included in the key layout adjustment-use image is selected and indicated with the indicator F.

Just as above, a key [1] and a key [2] are provided adjacent to each other in the key layout adjustment-use image, and the user presses the key [1] to select and indicate it.

If the error determination component 14d determines from the detection signal of the detector 19 that the user's finger has pressed the key [1] (step S14), then it is determined whether there is a no-touch state in which the user's finger has not pressed the key [1] (step S15).

Specifically, as shown in FIGS. 6(a) and 6(b), it is determined that the finger pressing the key [1] has entered the region D of the spacing between the keys [1] and [2].

The error determination component 14d determines by the detection signal from the detector 19 whether the user's finger has pressed the key [2] (step S16). This determination is performed for a specific length of time after a no-touch state in which the key [1] is not being pressed (step S17), and when the user's finger has pressed the key [2], a command is outputted to the image production component 14a to produce a manipulation-use image 101 of the key layout in which the spacing change component 14b has expanded the key spacing (e.g., the dimension of the spacing) by one level (step S18).

Specifically, when the finger pressing the key [1] enters the region C of the spacing between the keys [1] and [2], and it is determined that the key [2] has been pressed within a specific length of time assumed to be a normal manipulation of pressing the key [1], the manipulation-use image 101 in which the key spacing has been expanded by a specific level is produced and projected.

In the determination of whether the key [2] has been pressed (step S16), processing to expand the key spacing (step S18) can be skipped if a state in which the key [2] has been pressed continues for a specific length of time, or processing to expand the key spacing (step S18) can be performed even if this has continued for a specific length of time.

In the former case, as mentioned above, it can be assumed at the key [2] was pressed intentionally by the user, so it can be concluded that no erroneous detection has resulted from the narrow key spacing. If a state in which the key [2] is pressed only continues for a length of time that is shorter than the specified length, then it can be assumed that erroneous detection of the key [2] has occurred, and processing can be performed to expand the key spacing (step S18).

In the latter case, meanwhile, although there is some decrease in the precision at which the user's intention is ascertained, it can be concluded that there is the possibility of erroneous detection of the key [2], and even if a state in which the key [2] is pressed has continued for at least the specified length of time, processing to expand the key spacing (step S18) can be performed to prevent the occurrence of erroneous detection of the key [2].

If the key spacing is not changed as discussed above, then the image production component 14a stores a manipulation-use image of the current key spacing (step S19) so that it will be projected as a normal manipulation-use image 101, and this mode is ended (step S20).

Specifically, this corresponds to a case in which the finger pressing the key [1] does not cause erroneous detection of the key [2], and is lifted upward from the detection height range h, so this is stored as the manipulation-use image 101 at a key spacing at which no erroneous detection occurs.

The present invention can be utilized as an input device for a laser projector or another such image display device, and can also be utilized in input devices that receive input from a user with a projected manipulation-use image, in all electronic devices, such as personal computers, portable telephones, and portable information terminals.

In the illustrated embodiment, the input device includes a manipulation-use image display component, a detector, and an error determination component. The manipulation-use image display component projects and displays on a projection surface a manipulation-use image including a plurality of objects with which the user performs input manipulation with an indicator. The detector detects light reflected by the indicator in a detection range at a height from the projection surface. The error determination component determines detection related to a second object, which is adjacent to and at a spacing from a first object, to be in error when there is a situation in which detection by the detector in the region of the detection range corresponding to the first object and detection in the region of the detection range corresponding to the second object are performed continuously before and after detection in the region of the detection range corresponding to the spacing.

Therefore, even if the plurality of objects is adjacent at the spacing, erroneous detection of the user indication can be determined for these objects.

The manipulation-use image display component here can project and display the manipulation-use image using various kinds of light rays, but it is preferable to scan, project, and display the manipulation-use image with a laser beam because a sharper manipulation-use image can be projected and displayed, and very accurate detection with the reflected light can be performed, among other advantages.

Also, when the manipulation-use image is projected and displayed with a laser beam, it is possible to superpose the invisible laser light (such as infrared laser light) for use in reflection detection, apart from the laser beam that is used for scanning projection of the manipulation-use image.

Examples of the indicators include the user's finger, and a pen, stylus, or the like used by the user, but anything used by the user to indicate the object in the manipulation-use image is encompassed.

Also, examples of the plurality of objects in the manipulation-use image include a plurality of keys (such as a keyboard or a number pad), and function buttons or the like for actuating functions, but anything provided so as to demarcate a region within the manipulation-use image in order to accept manipulation input from the user is encompassed.

With this input device, it is preferable if the error determination component determines detection related to the second object to be in error if detection corresponding to the second object is shorter than a specific duration.

This allows detection error related to the second object to be determined more accurately by taking temporal conditions into account.

In the illustrated embodiment, the input determination method is an input determination method for determining an object that has undergone input manipulation with an indicator, by projecting and displaying on a projection surface a manipulation-use image including a plurality of objects with which the user performs input manipulation with the indicator, and detecting light reflected by the indicator in a detection range at a height from the projection surface wherein detection related to a second object, which is adjacent to and at a spacing from a first object, is determined to be in error when there is a situation in which detection in the region of the detection range corresponding to the first object and detection in the region of the detection range corresponding to the second object are performed continuously before and after detection in the region of the detection range corresponding to the spacing.

Therefore, even if the plurality of objects is adjacent at the spacing, erroneous detection of the user indication can be determined for these objects.

With the image display device and the input determination method, detection error of an object indicated by input manipulation by a user can be determined for a plurality of objects included in a projected and displayed manipulation-use image.

### Second Embodiment

A laser projector in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. In particular, the laser projector in accordance with the second embodiment is identical to the laser projector 1 illustrated in FIGS. 1 to 3, 4(a) and 4(b).

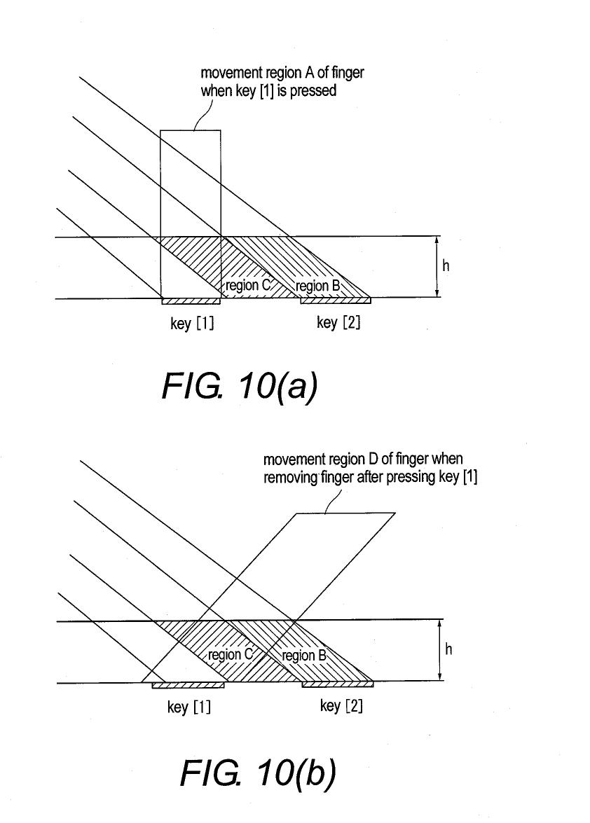

FIGS. 10 (a) and 10(b) show the relation between an object and the movement of a finger F in this indication and selection manipulation, using as an example keys [1] and [2], which are two adjacent objects. In FIGS. 10(a) and 10(b), h is the range of height over which the detector 19 (see FIGS. 2 and 3) detects reflected light.

As shown in FIGS. 10(a) and 10(b), the laser beam directly obliquely upward and projecting the manipulation-use image has in the detection height range h of the detector 19 a region of light projecting the key [1], a region B of light projecting the key [2], and a region C of light projecting the space between the key [1] and the key [2].

As shown in FIG. 10(a), in manipulation in which the finger F is pressed substantially straight down onto the desired object in the manipulation-use image (in this example, the key [1]), the finger F moves substantially directly over the movement region A.

The finger F pressing the key [1] reflects the laser beam projecting the key [1], and this reflected light is detected by the detector 19.

In manipulation in which the pressing finger F is lifted obliquely rearward, as shown in FIG. 10(b), the finger F moves through a movement region D that inclined toward the adjacent key [2].

However, in this manipulation, the finger F moving through the movement region D first goes through the region C where the key is not detected, and then passes through the region B, and the laser beam projecting the key [2] in the region B ends up being reflected, so the detector 19 also detects this reflected light.

Accordingly, in the series of manipulations in which the key [1] is depressed and then released, erroneous detection in which the key [1] and the key [2] are detected occurs in the detection height range h of the detector 19.

Since a state in which the two adjacent keys [1] and [2] are simultaneously depressed is not detected, a method can be employed in which detection of the next key is considered invalid unless the indicator has passed through a region in which a certain key is not detected after the detection of that key, but even with this method, erroneous detection will occur if the laser beam ends up being reflected in the region B after first passing through the region C, as discussed above.

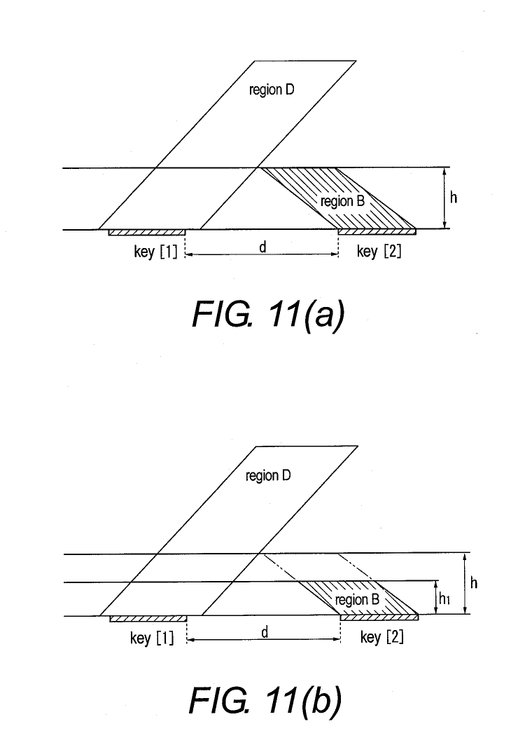

FIG. 11(a) shows a method for preventing the erroneous detection. The above-mentioned erroneous detection is prevented by projecting a manipulation-use image having an expanded spacing d between the key [1] and the key [2], so that the movement region D of the finger F lifted obliquely rearward will not enter the region B of the light projecting the key [2] in the detection height range h.

FIG. 11(b) shows another method for preventing the erroneous detection. The spacing d between the key [1] and the key [2] at which the movement region D does not enter the region B has a correlation with the height of the detection height range h. If the height of the detection height range is hl, which is lower than h, then the above-mentioned erroneous detection will not occur even if the object spacing d is narrow.

An example in which a manipulation-use image with changed object spacing is produced, projected and displayed in the above-mentioned input device component 10 (see FIG. 2) will now be described.

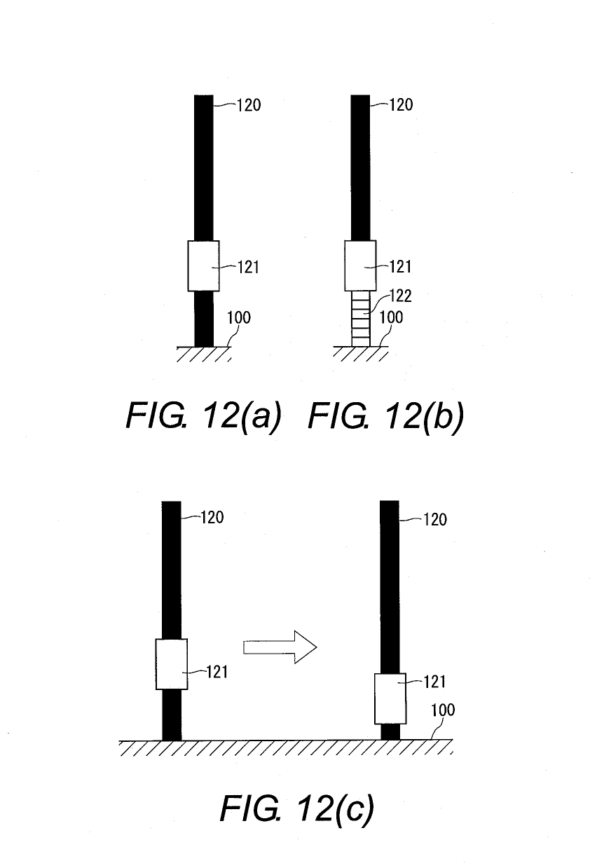

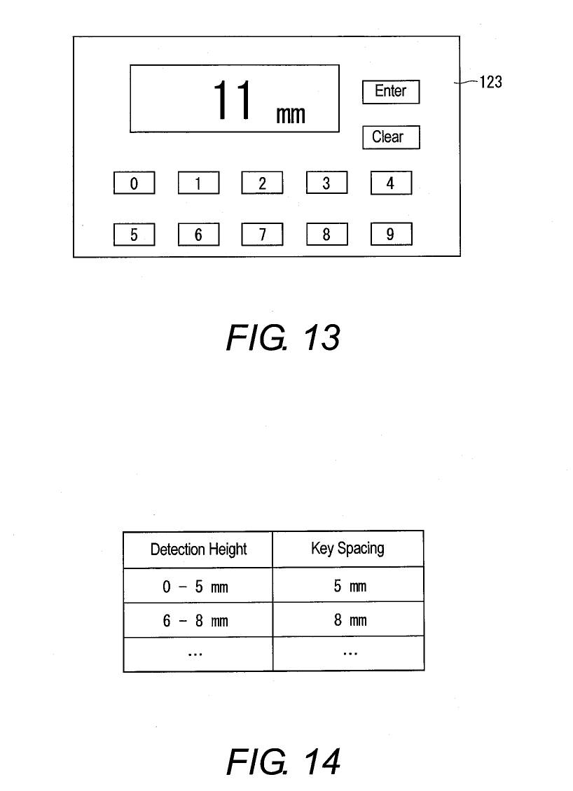

In this example, the spacing between the keys (objects) displayed in the manipulation-use image 101 is changed according to the height of the detection height range of the detector 19. The user uses the detection jig 120 shown in FIGS. 12(a) to 12(c) to detect the height of the detection height range, and inputs this height with the setting image shown in FIG. 13. As a result, the manipulation-use image 101 is projected with the keys laid out in a spacing at which the above-mentioned erroneous detection will not occur.

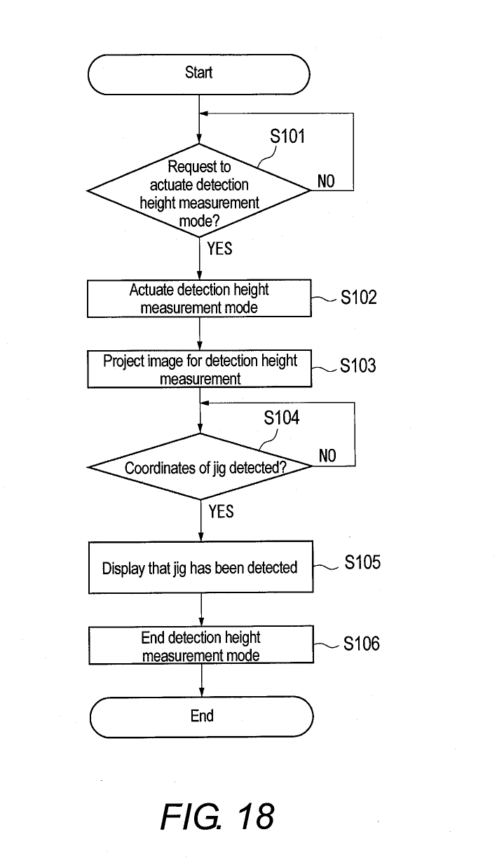

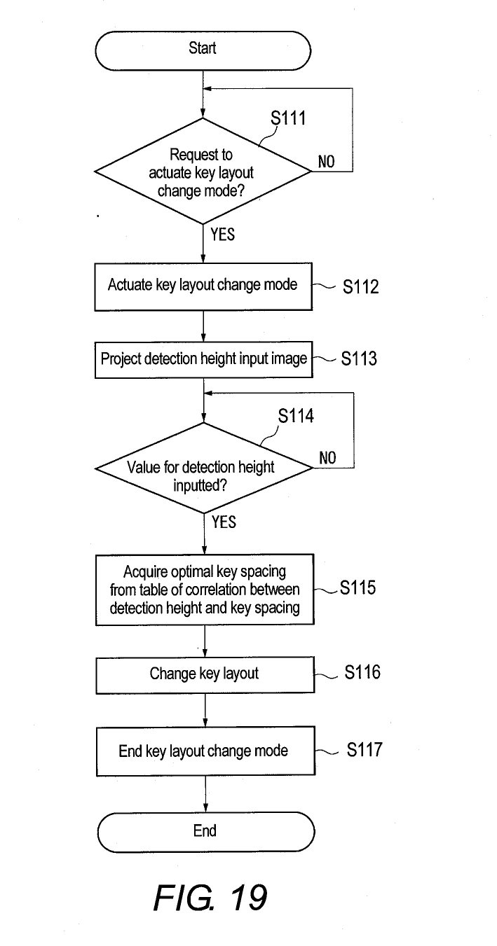

In this example, as shown in FIG. 14, the image processor 14, including the spacing change component 14b, etc., has a table of correlation with the key spacing and the height of the detection height range. The height input image shown in FIG. 13 is projected and displayed in order to input the detected height. The “detection height measurement mode” shown in FIG. 18 and the “key layout change mode” shown in FIG. 19 are executed according to user input from the input component 20 (see FIGS. 1 and 2). Also, a mode designation button or other such object can be provided in the manipulation-use image that is projected and displayed, and the “detection height measurement mode” or “key layout change mode” executed according to user input selecting and indicating this object.

In the detection height measurement mode shown in FIG. 18, when input from the user designating this mode is received from the input component 20 (step S101), the detection height measurement mode is actuated (step S102). Then, the image production component 14a produces an image for detection height measurement, which is projected on the projection surface 100 by laser beam as discussed above (step S103).

The image for detection height measurement can be an ordinary manipulation-use image, rather than readying a special image.

The user then uses the height detection jig 120 to measure the height range over which the reflected light is detected by the detector 19, with the image for detection height measurement projected and displayed on the projection surface 100.

The front side of the height detection jig 120 is shown in FIG. 12(a). As shown in the rear view in FIG. 12(b), this jig 120 is a rod-shaped member with a reflector 121 capable of sliding up and down. Graduations or scales 122 indicating the height of the reflector 121 from the installation surface 100 are provided to the jig 120.

As shown in FIG. 12(c), the user stands the height detection jig 120 on the projection surface 100 onto which the image for detection height measurement is projected. Then, gradually lowers the reflector 121 from a certain height, and reads the height from the graduations 122 when there is a detection notification from the input device component 10.

When the laser beam projecting the image for detection height measurement is reflected by the reflector 121 and detected by the detector 19 (step S104), then the image processor 14 outputs a detection notification to let the user know that the jig 120 has been detected (step S105), and then ends this mode (step S106).

This detection notification can be performed by any of various methods, so as long as it will make the user aware of the situation, but examples include changing the color of all or part of the image used for detection height measurement, and emitting a sound (such as a buzzer).

In detection height measurement mode, the height read from the graduations 122 when there has been a detection notification is the upper limit height of the detection range of the detector 19 (that is, the height range), and in key layout change mode, the key spacing is changed according to the height by inputting this measured height.

In the key layout change mode shown in FIG. 19, when input from the user designating this mode is received from the input component 20 (step S111), the key layout change mode is actuated (step S112). Then, the image production component 14a produces a detection height input image, which is projected on the projection surface 100 by laser beam as discussed above (step S113).

As shown in FIG. 13, a detection height input image 123 includes 0 to 9 number pad keys, an “enter” button for entering the numerical value (height) inputted with the number pad, and a “clear” button for clearing the inputted numerical value. When the user presses one of these keys or buttons with a finger F, the height (detection height range) is inputted from the graduations 122 at the point when there was a detection notification.

In this example, the detection height is inputted with a projected image (e.g., a height input component), but can be inputted with an interface provided to the input component 20 (e.g., a height input component).

When the height inputted from the detection height input image 123 is entered (step S114) at the image processor 14 (see FIG. 2), the spacing change component 14b (see FIG. 2) refers to the table shown in FIG. 14, acquires a key spacing corresponding to the inputted detection height (step S115), and then outputs this key spacing to the image production component 14a (see FIG. 2). In other words, the spacing change component 14b changes the dimension of the key spacing based on the height information of the detection range according to the table having a relation between the height information of the detection range and the dimension of the key spacing.

In this table, the minimum value for key spacing at which the above-mentioned erroneous detection will not occur when the user presses an object is preset according to the height of the detection range of the detector 19. In this example, the relation between height and key spacing is set in a table, but a computational formula for defining this relation can be set up, and the key spacing corresponding to the detection height calculated from this.

As an example of a computational formula, D=aZ+b can be used, where D is the key spacing, Z is the height of the detection range, a is a coefficient, and b is the default value for key spacing (decimal values are rounded off).

In this computational formula, if the coefficient a is ⅔ and the default value b for key spacing is 3, for example, then if the height Z of the detection range is 5 mm, the key spacing D will be approximately 6 mm. In any case (table or formula), the key spacing increases as the height of the detection range increases.

When the key spacing is inputted from the spacing change component 14b, the image production component 14a then changes the key spacing in the manipulation-use image 101 to this inputted key spacing, and produces a manipulation-use image 101 with this changed key spacing, which is projected and displayed by laser beam as discussed above on the projection surface 100 (step S116). Then, this mode is ended (step S117).

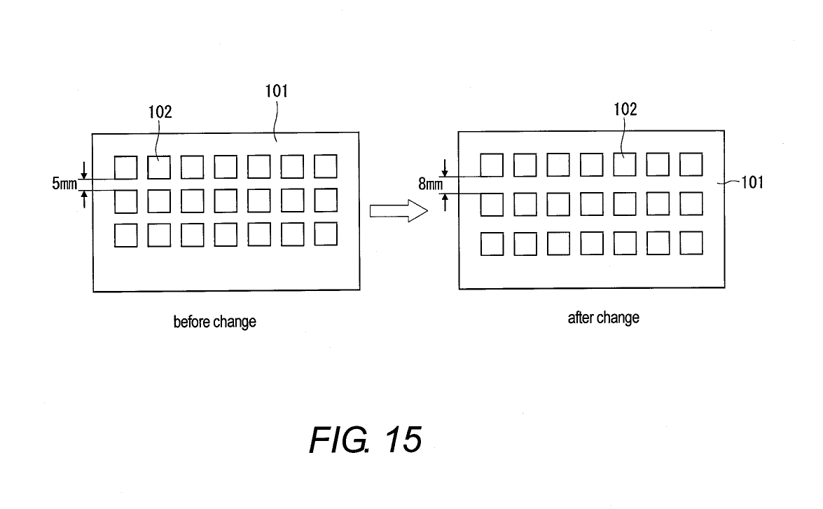

As shown in FIG. 15, for example, with the manipulation-use image 101 prior to the change, a plurality of keys are laid out at a spacing of 5 mm, but with the manipulation-use image 101 after the change, the keys are laid out at a spacing of 8 mm. The example depicted here corresponds to a case when the detection height is 6 to 8 mm (refer to FIG. 14), and the above-mentioned erroneous detection occurs when the key spacing is left at 5 mm.

In this example, the key spacing is changed by expanding the key spacing. Of course, if the measured height of the detection range is low, then the key spacing can be narrowed by inputting a lower height. Again when the key spacing is thus narrowed, erroneous detection can be prevented by using a key spacing corresponding to the height, and this is actually advantageous in that the layout of the keys or other objects can be made more compact.

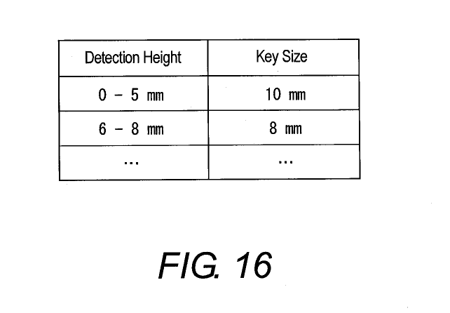

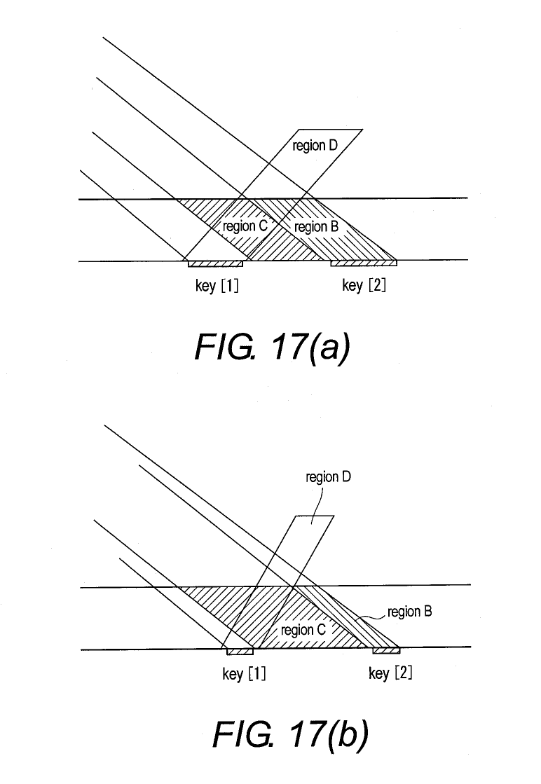

FIGS. 16, 17(a) and 17(b) show modification examples of the above-mentioned example. In these modification examples, the key spacing is changed by changing the size of the keys (objects).

Specifically, if the height inputted from the detection height input image 123 is entered in the processing of the key layout change mode shown in FIG. 19 (step S114), then the spacing change component 14b refers to the table shown in FIG. 16, and acquires the key size corresponding to the inputted detection height (step S115), which is outputted to the image production component 14a.

In this table, the minimum value for key spacing at which the above-mentioned erroneous detection will not occur in an object layout range of a specified size is preset according to the height of the detection range of the detector 19. In this example, the relation between height and key size is set in a table, but a computational formula for defining this relation can be set up, and the key size corresponding to the detection height calculated from this. In any case (table or formula), the key size decreases as the height of the detection range increases.

When the key size is inputted from the spacing change component 14b, the image production component 14a then changes the key size in the manipulation-use image 101 to this inputted key size, and produces a manipulation-use image 101 with this changed key size, which is projected and displayed by laser beam as discussed above on the projection surface 100 (step S116), and this mode is then ended (step S117).

As shown in FIG. 17(a), for example, with the finger pressing the key [1] is lifted obliquely rearward, the finger F moving through the movement region D first goes through the region C in which no key is detected, then passes through the region B of the key [2], resulting in erroneous detection by the detector 19. On the other hand, as shown in FIG. 17(b), if the size of the keys [1] and [2] are reduced, the spacing between the keys [1] and [2] expands, so that the finger moving through the movement region D will not pass through the region B of the key [2].

In the above-mentioned example, the detection height range of the detector 19 is inputted, and the spacing of keys in the manipulation-use image 101 is changed based on this. On the other hand, in another example, erroneous detection of a key pressing manipulation by the user is automatically determined by the error determination component 14d, and key layout adjustment mode processing for changing the key spacing is performed as a result.

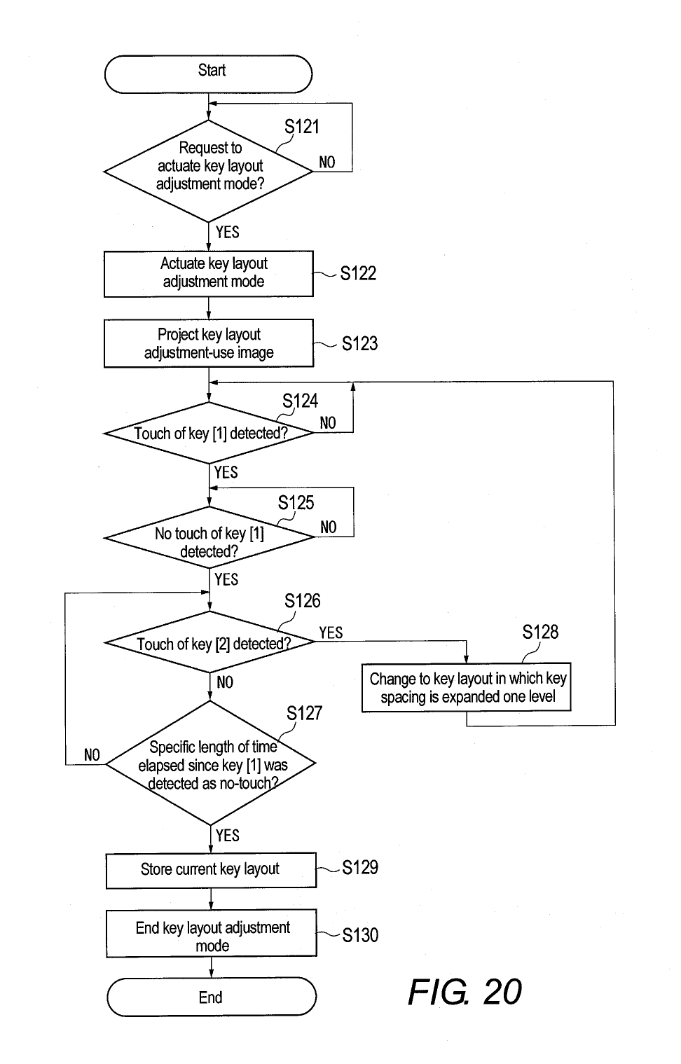

In the key layout adjustment mode shown in FIG. 20, when input from the user designating this mode is received from the input component 20 (step S121), the key layout adjustment mode is actuated (step S122), and the image production component 14a produces a key layout adjustment-use image, which is projected by laser beam as discussed above onto the projection surface 100 (step S123).

The key layout adjustment-use image can be an ordinary manipulation-use image, rather than readying a special image.

In the key layout adjustment mode, the user performs manipulation with the indicator F to select and indicate one of the objects included in the key layout adjustment-use image.

Just as above, an example will be described in which a key [1] and a key [2] are provided adjacently to the key layout adjustment-use image, and the user presses the key [1] with the finger F to select and indicate that key.

If the error determination component 14d determines from the detection signal of the detector 19 that the user's finger has pressed the key [1] (step S124), then it determines whether or not there is a no-touch state in which the user's finger is not pressing the key [1].

Specifically, as shown in FIG. 10(b), it is determined that the finger pressing the key [1] has entered the region C of the spacing between the keys [1] and [2].

The error determination component 14d also determines from the detection signal of the detector 19 whether or not the user's finger has pressed the key [2] (step S126). This determination is performed for a specific length of time after reaching the no-touch state in which the key [1] is not being pressed (step S127), and if the user's finger has pressed the key [2], a command is outputted to the image production component 14a so as to produce the manipulation-use image 101 with a key layout in which the key spacing has been expanded by one level (step S128).

Specifically, as shown in FIG. 10(b), if it is determined that the finger pressing the key [1] has entered the region C of the spacing between the keys [1] and [2], and that the key [2] has been pressed within a specific length of time assumed to be the normal manipulation for pressing the key [1], then the manipulation-use image 101 in which the key spacing has been expanded by a specific level is produced and projected. In particular, in the illustrated embodiment, the key spacing can be expanded by changing or reducing the key spacing between adjacent rows of keys in the manipulation-use image 101, as shown in FIG. 15, by a predetermined amount, or by changing or reducing the size of keys in the manipulation-use image 101, as shown in FIGS. 17(a) and 17(b), by a predetermined amount. In other words, in the illustrated embodiment, the spacing change component 14b increases the dimension of the key spacing of the projection image (step S128) in response to the error determination component 14d determining that the user input operation of the key [2] is erroneously detected (step S126). In the illustrated embodiment, the spacing change component 14b alternatively increases the dimension of the key spacing of the projection image by decreasing a size of the keys [1] and [2] (step S128). Furthermore, in the illustrated embodiment, the error determination component 14d determines that the user input operation of the key [2] is erroneously detected (step S126) in response to the detector 19 detecting the finger F in the region E corresponding to the key [2] within a predetermined length of time after the detector 19 detects the finger F in the region corresponding to the key [1].

On the other hand, if the user's finger has not pressed the key [2] within the above-mentioned specific length of time, the image production component 14a stores the manipulation-use image of the current key spacing so that the normal manipulation-use image 101 will be projected (step S129), and this mode is ended (step S130).

Specifically, this corresponds to a case in which the finger pressing the key [1] has gone above the detection height range h enters the region C between the keys [1] and [2] without entering the region B of the key [2]. Thus, this is stored as the manipulation-use image 101 with the key spacing at which erroneous detection will not occur.

The present invention can be utilized as an input device for a laser projector or another such image display device, and can also be utilized in input devices that receive input from a user with a projected manipulation-use image, in all electronic devices, such as personal computers, portable telephones, and portable information terminals.

In the illustrated embodiment, the input device includes a manipulation-use image display component, a detector, and a spacing change component. The manipulation-use image display component projects and displays on a projection surface a manipulation-use image including a plurality of objects with which the user performs input manipulation with an indicator. The detector detects light reflected by the indicator in a detection range at a height from the projection surface. The spacing change component changes the object spacing of the manipulation-use image projected and displayed by the manipulation-use image display component.

Therefore, erroneous detection of objects indicated by the user can be prevented by changing the object spacing according to the height of the detection range.

The manipulation-use image display component here can project and display the manipulation-use image using various kinds of light rays, but it is preferable to scan, project, and display the manipulation-use image with a laser beam because a sharper manipulation-use image can be projected and displayed, and very accurate detection with the reflected light can be performed, among other advantages.

Also, when the manipulation-use image is projected and displayed with a laser beam, it is possible to superpose the invisible laser light (such as infrared laser light) for use in reflection detection, onto the laser beam that is used for scanning projection of the manipulation-use image.

Examples of indicators include the user's finger, and a pen, stylus, or the like used by the user, but anything used by a user to indicate an object in a manipulation-use image is encompassed.

Also, examples of the plurality of objects in the manipulation-use image include a plurality of keys (such as a keyboard or a number pad), and function buttons or the like for actuating functions, but anything provided so as to demarcate a region within a manipulation-use image in order to accept manipulation input from a user is encompassed.

The input device includes a height input component that receives height information about the detection range from the user. The spacing change component has a relation between the height of the detection range and the object spacing, and changes the object spacing of the manipulation-use image according to the height information received from the height input component depending on this relation. This allows the object spacing to be changed by the user by inputting height information about the detection range.

The input device further includes an error determination component that determines erroneous detection of input manipulation by the detector. The detector detects input manipulation to a second object adjacent to a first object in the manipulation-use image within a specific length of time after the detection of input manipulation to the first object. The spacing change component expands the object spacing of the manipulation-use image in response to determination by the error determination component of erroneous detection of input manipulation. This expands the object spacing when erroneous detection occurs between a plurality of adjacent objects.

With the input device, in addition to a method in which the spacing change component simply increases the distance between objects when the object spacing is to be expanded, it is also possible to employ a method in which the object spacing is expanded by reducing the size of the objects. With this latter method, if there is a keyboard image, for example, rather than making the whole keyboard larger, the spacing between the keys included in the keyboard can be expanded.

The laser input device can be used in a laser projector or another such image display device.

The image display device includes a first image display component, a second image display component, a detector, and a spacing change component. The first image display component projects and displays a display-use image on a first projection surface. The second image display component projects and displays on a second projection surface a manipulation-use image including a plurality of objects with which the user performs input manipulation with an indicator. The detector detects light reflected by the indicator in a detection range at a height from the second projection surface. The spacing change component changes the object spacing of the manipulation-use image projected and displayed by the second image display component.

Here, it is preferable if the display-use image is displayed by being scanned and projected with a laser beam, because a sharper manipulation-use image can be projected and displayed, among other advantages.

Also, when a display-use image is projected and displayed with a laser beam, it is preferable to use a MEMS (Micro Electro Mechanical System) type of scanning mirror as the scanning component that scans the laser beam because it is more compact, consumes less power, and affords faster processing, among other advantages.

Also, with the image display device, a mode in which the display-use image and the manipulation-use image are both the same image can be employed, as can a mode in which they are different images.

With the image display device and the input determination method, erroneous detection of objects indicated by the user can be prevented in an input device and an image display device which project and display a manipulation-use image including a plurality of objects with which the user performs input manipulation.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image display device comprising:
an image display component configured to project on a projection surface a projection image with at least first and second input objects for a user input operation using an indicator, the first and second input objects being adjacently arranged in the projection image with a spacing therebetween;
a detector configured to detect the indicator in a detection range that extends in a height direction of the projection surface; and
an error determination component configured to determine that the user input operation of the second input object is erroneously detected in response to the detector continuously detecting the indicator in regions of the detection range corresponding to the first input object, the spacing and the second input object, respectively.

2. The image display device according to claim 1, wherein
the error determination component is configured to determine that the user input operation of the second input object is erroneously detected in response to the detector detecting the indicator in the region of the detection range corresponding to the second input object for a time period that is shorter than a predetermined time period before the detector stops detecting the indicator in the region of the detection range corresponding to the second input object.

3. The image display device according to claim 1, wherein
the detector is configured to detect the indicator by detecting light reflected by the indicator.

4. The image display device according to claim 1, further comprising
a spacing change component configured to that change a dimension of the spacing of the projection image projected by the image display component.

5. The image display device according to claim 4, further comprising
a height input component configured to receive height information of the detection range,
the spacing change component being configured to change the dimension of the spacing of the projection image based on the height information of the detection range according to a relation between the height information of the detection range and the dimension of the spacing.

6. The image display device according to claim 4, wherein
the spacing change component is configured to increase the dimension of the spacing of the projection image in response to the error determination component determining that the user input operation of the second input object is erroneously detected.

7. The image display device according to claim 6, wherein
the error determination component is configured to determine that the user input operation of the second input object is erroneously detected in response to the detector detecting the indicator in the region of the detection range corresponding to the second input object within a predetermined length of time after the detector detects the indicator in the region of the detection range corresponding to the first input object.

8. The image display device according to claim 4, wherein
the spacing change component is configured to increase the dimension of the spacing of the projection image by decreasing a size of the first and second input objects.

9. The image display device according to claim 1, further comprising
an additional image display component configured to project on an additional projection surface a display image.

10. The image display device according to claim 9, further comprising
a spacing change component configured to change a dimension of the spacing of the projection image projected by the image display component.

11. An input determination method comprising
projecting on a projection surface a projection image with at least first and second input objects for a user input operation using an indicator, the first and second input objects being adjacently arranged in the projection image with a spacing therebetween;
detecting the indicator in a detection range that extends in a height direction of the projection surface; and
determining that the user input operation of the second input object is erroneously detected in response to continuously detecting the indicator in regions of the detection range corresponding to the first input object, the spacing and the second object, respectively.
